(19) United States
(12) Patent Application Publication
(10) Pub. No.: US 2011/0041647 A1
(43) Pub. Date: Feb. 24, 2011

(54) BRAKE PEDAL ASSEMBLY HAVING NON-CONTACTING SENSOR

(76) Inventor: Jarek Soltys, Chatham (CA)

Correspondence Address: GIFFORD, KRASS, SPRINKLE,ANDERSON & CITKOWSKI, P.C, PO BOX 7021, TROY, MI, 48007-7021, US

(21) Appl. No.: 12/858,766

(22) Filed: Aug. 18, 2010

Related U.S. Application Data
(60) Provisional application No. 61/234,822, filed on Aug. 18, 2009.

(51) Int. Cl. G05G 1/44

(52) U.S. Cl. 74/560

(57) ABSTRACT

A pedal assembly using a non-contacting position sensor utilizing a spring-biased roller on a cam surface to simulate the feel of a conventional brake pedal is provided. The pedal assembly includes an elongated brake support bracket having a cam surface and a pedal arm having a spring-biased roller. A spring-biased roller assembly is mounted to an inward side or beside the pedal arm or on both sides of the pedal arm. The roller assembly includes a fixed leg extending on from an inner side of the pedal arm and a movable leg which is pivotally mounted to the pedal arm. A biasing member extends over the support between the fixed leg and movable leg to generate a biasing force against the roller. When the pedal is depressed, the roller is moved along the cam surface of the support bracket thereby creating the ‘feel’ of a traditional pedal assembly.

### CROSS-REFERENCE TO RELATED APPLICATIONS

This application claims priority of U.S. Provisional Patent Application Ser. No. 61/234,822 filed Aug. 18, 2009, which is incorporated herein by reference.

### BACKGROUND OF THE INVENTION

I. Field of the Invention

The present invention relates generally to brake pedals and, more particularly, to a brake pedal assembly having a non-contacting sensor.

II. Description of Related Art

It is known to use position sensors on pedal assemblies for “by wire” vehicle controls such as brake pedals and gas pedals. The position sensor generates an electrical signal indicative of the amount of depression of the pedal. A controller uses this signal to control the operation of a throttle or braking assembly. However, it is desirable to provide these pedal assemblies with a resistance to depression or “feel” which is similar to that of a conventional pedal assembly. Accordingly, it is desirable to provide a pedal assembly for a vehicle using a position sensor which simulates the feel of a conventional brake pedal which is light weight and inexpensive to produce.

### SUMMARY OF THE PRESENT INVENTION

A pedal assembly is provided using a non-contacting position sensor utilizing a spring-biased roller on a cam surface to simulate the feel of a conventional brake pedal. The pedal assembly includes an elongated brake support bracket having a cam surface and a pedal arm having a spring-biased roller. A pair of arms extend from one end of the bracket. The arms are spaced apart to accept a top portion of the pedal arm. A pivot rod extends through the arms and pedal arm to support the pedal arm for pivotal motion. A non-contacting rotational position sensor is mounted on one of the arms.

The pedal arm is an elongated member supported at one end by the pivot rod and having a pedal pad at the opposite end. A spring-biased roller assembly is mounted to an inward side or beside the pedal arm. The roller assembly includes a fixed leg extending on from an inner side of the pedal arm and a movable leg which is pivotally mounted to the pedal arm. A roller support has a pair of spaced apart flanges for supporting a roller, one end is attached to the free end of the movable leg and the other end of the roller support is pivotally attached to the fixed leg.

A biasing member extends over the support between the fixed leg and movable leg to generate a biasing force against the roller. When the pedal is depressed, the roller is moved along the cam surface of the support bracket. The radius of curvature of the cam is coordinated with the force of the spring to produce a load which simulates the feel of a conventional brake pedal assembly.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a perspective view of the pedal assembly where the pedal arm is not depressed;

FIG. 2 is a perspective view of the pedal assembly having a non-contacting position sensor wherein the pedal arm is fully depressed; and

FIG. 3 is a perspective view of an alternative embodiment of the pedal assembly having a non-contacting position sensor.

### DETAILED DESCRIPTION OF A PREFERRED EMBODIMENT OF THE PRESENT INVENTION

As pedal assembly 10 using a non-contacting position sensor utilizes a spring-biased roller on a cam surface to simulate the feel of a traditional brake pedal. The pedal assembly 10 is particularly suited for hybrid vehicles. As the pedal is depressed, the amount of load required to further depress the pedal increases.

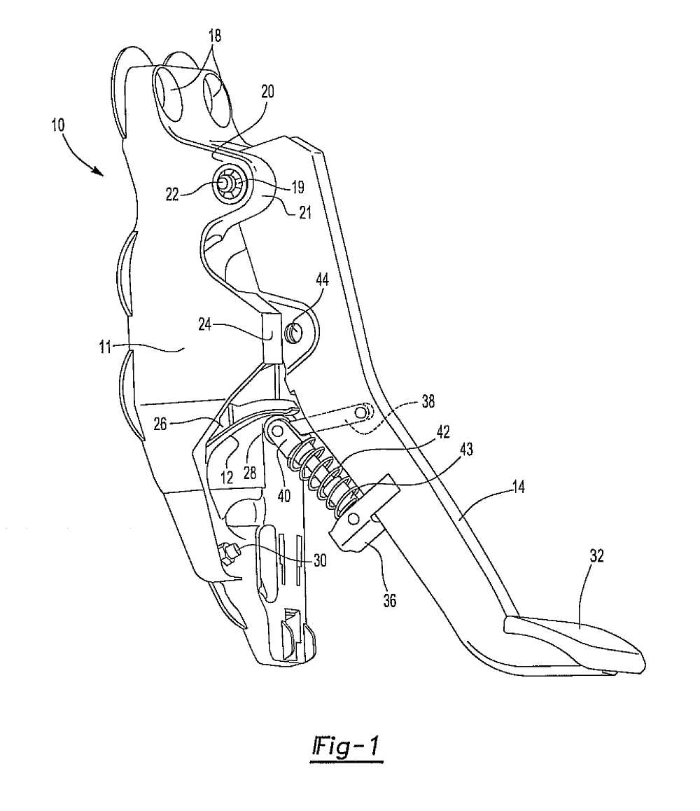

The pedal assembly 10 includes a brake support bracket 11 and a support 26 having a cam surface 12. The pedal assembly 10 further includes a pedal arm 14 having a spring-biased roller 28 as shown in FIG. 1. The support 26 is an elongate member having the base bracket 11. The pedal assembly 10 having apertures 18 for mounting to the vehicle. A pair of arms 20 extend from one the pedal assembly 10. The arms 20 are spaced apart to accept a top portion of the pedal arm 14.

A pivot rod 22 extends through the arms 20 and pedal arm 14 to support the pedal arm 14 for pivotal motion. The interaction between the pivot rod 22, the arms 20 and the pedal arm 14 form a pivot point at pivot rod 22 where the pedal arm 14 can easily pivot about. Push nut 19 retains the pivot rod 22.

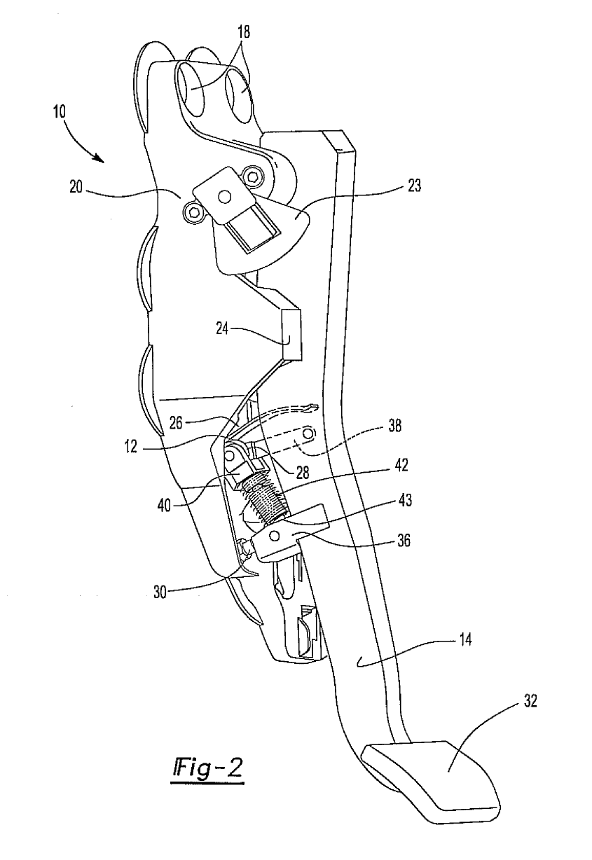

A non-contacting rotational position sensor 23 is mounted on one of the arms 20 as shown in FIG. 2. Many different types of non-contacting position sensors can be used, such as eddy current and Hall Effect sensors, however in the preferred embodiment the position sensor of the type disclosed in U.S. Pat. Nos. 7,221,154; 7,276,897 and 7,345,473, and owned by the assignee of this invention.

A mounting area 24 for a switch for controlling the deactivation of a cruise control is also provided. Extending from a middle portion of the base portion is a mounting area 24 for support of the cruise deactivation switch.

Also extending upwardly from the base is the support 26 having the cam surface 12. The cam surface supports the roller 28 attached on the pedal arm as discussed more fully below. The support 26 and cam surface 12 is made of a plastic, polymer or metal material. The cam surface 12 may have different finishes, such as smoother or rougher surfaces, to further manipulate the feel of the pedal assembly 10 when in operation by the driver to simulate the feel of a traditional brake pedal. The support 26 is preferably molded of a suitable plastic and the cam surface 12 may be formed of a plastic molded over a metal substrate.

Opposite the apertures 18 along the length of the pedal assembly 10 is a pin 30 which extends outwardly to act as a stop to the pedal arm. The pin 30 is made of a plastic, polymer or soft material as to not damage the pedal arm 14. The pin 30 may also be made of a metal.

As shown in FIG. 1, the pedal arm 14 is an elongated member supported at one end by the pivot rod 22 and having a pedal pad 32 at the opposite end. The pedal pad 32 includes a plastic or polymer material to facilitate gripping of the driver's shoe to the pedal arm. A spring-biased roller 28, roller support 40 and spring 42 are mounted to an inward side or beside the pedal arm 14. A fixed leg 36 extending from an inner side of the pedal arm 14 and a movable leg 38 which is pivotally mounted to the pedal arm 14. A roller support 40 has a pair of spaced apart flanges for supporting a roller, one end is attached to the free end of the movable leg and the other end of the roller support 40 is pivotally attached to the fixed leg 36. The roller support 40 varies in configuration as shown by the accompanying figures.

A spring 42 extends between spring support 43 (pivotally linked to movable leg 38) and the roller support 40 generating a biasing force against roller 28. The roller 28 may be provided with bearings and a smooth surface so that the roller moves evenly along the cam surface. When the pedal arm 14 is depressed, the roller 28 is moved along the cam surface 12 of the support bracket 11.

The curvature of the cam surface 12 is such that the roller is forced inwardly towards the fixed leg 36 to compress the spring and increase the load or resistance to depression. The radius of curvature of the cam surface 12 is coordinated with the force of the spring to produce a load which simulates the feel of a conventional brake pedal assembly. Higher and lower radiuses of curvature of the cam surface produce different impacts of force felt by the driver. The varying degrees of force produced by the roller 28, spring 42 and the cam surface 12 are modified according to the requirements of the driver.

As shown in FIG. 2, the pedal arm 14 is in a depressed position. The compressed pedal arm 14 depicts the position of the pedal arm when a vehicle driver is braking to the fullest capacity in conventional braking mode. The pedal aim 14 having the pedal pad 32 pivots about the pivot point at pivont rod 22. Located atop or near the pivot point at pivont rod 22 and on one of the arms 20 is the sensor 23. The pedal assembly 10 further includes apertures 18 to mount the pedal assembly 10 to a motor vehicle. The arms 20 of the pedal assembly 10 extent towards the vehicle driver. In the present embodiment, the pedal assembly 10 includes two arms 20 having a rounded end portion 21.

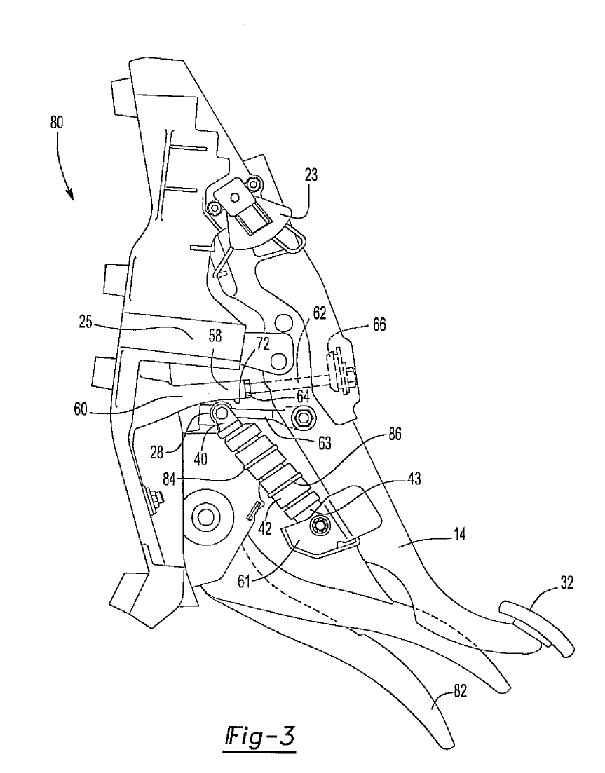

In an alternative embodiment as shown in FIG. 3, a pedal assembly 80 is provided having a biasing member or spring 42 used in connection with a fixed leg 61 and a movable leg 63. A spring 42 extends between spring support 43 and the pivoting roller support 40 generating a biasing force against roller 28. A cam surface 72 is provided including an up stop bolt 62. The support 60 includes an upper portion 58 wherein the bolt 62 connects to the support 60 by means of the opening or acceptor 64. The bolt 62 extends up from the cam 58 and protrudes through the pedal arm 14 to set the home position for the sensor 23. Coupling nut 66 secures the bolt 62 to the cam setting the proper home position of the pedal arm 14.

The spring 42 is connected to a roller support 40. The roller support 40 is connected to a roller 28 operable to roll on the earn surface 72 the a support 60. The rolling of the roller 28 on the cam surface 72 together with the bolt 62 together with the depression of the spring 42 work together to simulate the feel of a traditional brake pedal.

The spring 42 is made of rubber, an elastomer or wire or alike. In the present embodiment, the spring 42 is a natural rubber compression spring. The natural rubber compression spring 42 adds hysteresis to further simulate the feel of a conventional brake system. The elastomer could be combined with plastic or steel rings 84, 86. As shown in FIG. 3, cylindrical rings 84, 86 are provided in the spring 42. The cylindrical rings 84, 86 prevent the spring from collapsing. Radial cuts or protrusions in the spring 42 are added to retain the cylindrical rings 84, 86 thereby preventing the spring 42 from collapsing.

Furthermore, the cross section of the spring 42 may vary throughout its length to provide varying load during compression. Grooves, chamfers and radii reduce the initial spring force, but allows for compression of any set which the spring throughout the life of the spring 42.

A brake rod may be attached to the pedal arm at the aperture 44. The brake rod is toggled so that in aggressive braking situations the brake rod may be used to actuate the brakes of the vehicle.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

I claim:

1. A brake pedal assembly having a non-contacting position sensor having a pedal arm pivotally mounted about a first pivot point to a bracket operable to simulate the feel of a conventional brake pedal, the pedal assembly comprising:
a pedal arm mounted to the bracket;
a roller; and
a cam surface mounted to one of either the bracket or the pedal arm, the roller mounted to the other of the bracket or the pedal arm.

2. The brake pedal assembly of claim 1, wherein a biasing member is mounted to the pedal aim to bias the roller against the cam surface.

3. The brake pedal assembly of claim 2, wherein the biasing member is a spring.

4. The brake pedal assembly of claim 3, wherein at least one cylindrical ring is integrated within the spring.

5. The brake pedal assembly of claim 4, wherein the spring includes grooves to assist in positioning the at least one cylindrical ring.

6. The brake pedal assembly of claim 4, wherein the spring includes protrusions to assist in positioning the at least one cylindrical ring.

7. The brake pedal assembly of claim 3, wherein the spring is a natural rubber.

8. The brake pedal assembly of claim 3 wherein a cross section of the spring varies in dimension throughout the length of the spring.

9. The brake pedal assembly of claim 2, wherein the biasing member is a damper.

10. The brake pedal assembly of claim 1, wherein a support member having a first end and a second end, the first end mounted to the pedal arm.

11. The brake pedal assembly of claim 10, wherein the roller is mounted to the second end of the pedal arm.

12. The brake pedal assembly of claim 11, wherein a fixed leg is attached to the pedal arm.

13. The brake pedal assembly of claim 13, wherein the second end of the support member is pivotally mounted to the fixed leg.

14. The brake pedal assembly of claim 1, wherein a movable leg is disposed between the pedal arm and the roller.

15. The brake pedal assembly of claim 15, wherein the movable leg is pivotally connected to the pedal arm.

16. The brake pedal assembly of claim 15, wherein the movable leg is pivotally connected to the roller.

17. The brake pedal assembly of claim 15, wherein the movable leg is an elongated member.

18. The brake pedal assembly of claim 1, wherein the first surface of the cam has a first radius of curvature.

19. The brake pedal assembly of claim 1, wherein the pedal assembly includes two arms.

20. The brake pedal assembly of claim 20, wherein the pedal arm is pivotally mounted between the two arms.

21. The brake pedal assembly of claim 20, wherein the position sensor is mounted on one of the two arms.

22. The brake pedal assembly of claim 1, wherein the pedal assembly further includes a bolt to maintain position of the pedal arm.

23. The brake pedal assembly of claim 18, wherein the bolt connects to the pedal arm.

24. The brake pedal assembly of claim 24, wherein the bolt is elongated.
